(19) United States
(12) Patent Application Publication
(10) Pub. No.: US 2012/0059765 A1
(43) Pub. Date: Mar. 8, 2012

(54) Web-based Immigration Case Creation System

(76) Inventors: Samuel Alemu, Elgin, IL (US); Praveen Chakravarthy Medikundam, Eligin, IL (US)

(21) Appl. No.: 12/876,004

(22) Filed: Sep. 3, 2010

(51) Int. Cl. G06Q 50/00

(52) U.S. Cl. 705/311

(57) ABSTRACT

The present invention “Web-based Immigration Case Creation System” pertains to the web-based method of creating and assigning a case to immigration attorneys. Following Clients' request, the invention assigns individual log-in IDs and passwords to the customer portal enabling clients to log-into their individual account and space. Once in their account in the customer portal, clients can create cases in just few clicks and get an instant e-mail confirmation with a case petition number. The invention also continues to benefit clients, their beneficiaries, and attorneys servicing as a one medium of communication through which various supporting documents are uploaded, comments and instructions are given to each case created using the web-based case creation system.

### FIELD OF THE INVENTION

The present invention relates to immigration cases, and more particularly to a web-based immigration cases creation method; by enabling Clients to log-in to their personal customer portal and create various types of immigration cases for themselves and/or other beneficiaries.

### BACKGROUND OF THE INVENTION

Immigration related services require constant follow-ups and filing of various petitions with the concerned government authorities from time to time. Immigration petitions are highly complicated and need very high degree of expertise in representation. Often immigration petitions are extremely time sensitive and have to be filed well within the time prescribed by the law. Taking into account this complex nature, most immigration cases are represented by attorneys with the required qualification and experience. Thus contacting immigration attorneys by a client and assigning the case is the first step in the legal representation. However, contacting attorneys who are busy handling numerous cases is tedious, time consuming and expensive.

Often, clients fail to meet the deadlines for lack of accessibility to attorneys to assign their cases. Assigning the case to the attorney and getting the representation well before the deadline is the key for a success of any immigration petition. Clearly, then, there is a need for a system that can be used by clients to assign their cases to immigration attorneys at any time using web based application. This web based application will make the process of contacting attorneys and assigning cases easier and timely.

### BRIEF SUMMARY OF THE INVENTION

The general idea and object of the invention is to enable clients, who are in need of immigration services, have a secured, easy and guaranteed access to qualified attorneys. As discussed above under “Background of the Invention”, clients who hold time sensitive immigration cases faces a considerable problem of getting in touch with and assigning their cases to qualified attorneys. The invention at hand alleviates this problem considerably as follows:

1. Clients will have 24/7 access to qualified attorneys;

2. By using this invention, Clients will avoid the ever tedious, time consuming and expensive process of contacting attorneys and assigning their cases to them. Clients are assured of timely execution of their time sensitive cases

3. Clients and/or their beneficiaries will never ever wonder about the status of their cases as every single step in their cases is updated for them to see on the invention; and

4. The invention also creates a medium through which attorneys, clients and their beneficiaries upload necessary and supporting documents regarding their immigration case without the need for them to actually send hard copies. This considerably saves time and money. Moreover, clients will be able to give special instructions and comments from time to time right in their customer portal.

5. Transparency, which is an important element in immigration cases, is achieved through the invention at hand. Immigration cases require a high degree of transparency between attorneys and clients. The web-based immigration case creation system, allows clients and their beneficiaries to closely follow the steps taken by the lawyer from their personal account in the customer portal. At any given point of time, Clients and their beneficiaries are able to log in to their customer portal and review the forms, court briefs or letters drafted in support of their case, and make any comments and suggestions as they deem necessary. This highly increases the transparency of the whole case handling process by attorneys.

### DETAILED DESCRIPTION OF THE INVENTION

The present invention is a web based application that effectively allows the client to log into designated customer portal and create the immigration case to be assigned to the attorney. The following is a detailed and step-by-step description of the invention and the procedure associated with the same.

FIRST: Client will request the attorney's office to assign them the login Id and password for accessing the customer portal. Clients can easily request for such login Id and password right from the film's website at www.bizlegalservices.com. The “New User Registration” feature will allow clients to make the request.

SECOND: Immediately after placing the request, clients will be provided with their log-in Id and password to use the customer portal. “My Esq. Customer Portal” feature in the above mentioned website will enable clients to log-in to their new customer portal.

THIRD: At customer portals, clients are just few clicks away to qualified immigration attorneys. Upon getting the access to the customer portal, clients will login to select the nature of petition they want to assign the attorney from the available list of various kinds of immigration petitions. Clients at this point need to only provide limited information about the type of their immigration cases, their contact details and that of their beneficiaries (if it applies). The “Submit” button at the portal completes the tedious and time consuming attorney contacting and case assigning process for clients. The case automatically is assigned to attorneys through their web-interface and e-mail confirmation will be forwarded to clients regarding the cases they just created along with the case number.

FOURTH: Assume the client is an IT company having 50-70 foreign employees in need of immigration services. After creating a case using the customer portal, client has to inform each and every employee about the created cases and the steps being taken. This is time , consuming, unrealistic sometimes and interferes with the overall performance of the company. With the use of this invention; however, clients avoid this kind of scenarios. The invention automatically sends out e-mails to all concerned beneficiaries with links to the cases created and with further instructions on how to upload their supporting documents in the , customer portal. The instructions in the e-mail will be forwarded in the form of hyperlinked link.

FIVTH: Again, assume clients and/or their beneficiaries being located in different parts of the U.S., or even in different parts of the world. Clients/beneficiaries will have to physically send their documents for attorneys review. The cost and loss of time associated with this process is considerable. With the invention at hand, clients and their beneficiaries upload necessary documents right in the customer portal for attorneys' immediate review and handling.

SIXTH: Once cases are created and documents are uploaded, attorneys continue to work on the cases and update the progress each time in the customer portal for the clients and beneficiaries to see and keep track of their cases. This feature relieves clients and beneficiaries from their worries and concerns as to the fate of their time sensitive cases.

The present invention saves lot of time, money and effort in contacting attorneys for case evaluation, representation or just advices. Clients can assign the cases to attorneys any time by accessing the web-based application, thus, saving time and expediting the whole process. Since the process of creating and assigning the case is web based, it can be used by clients at anytime, not just during normal business hours which limit the accessibility of attorneys. The client doesn't have to wait for days and long hours trying to create the important, time sensitive cases to be examined by the immigration attorneys. Furthermore, the present application does not involve downloading or buying any additional software and relatively simple to use for creating, verifying and retrieving the petition documents and status online.

### DRAWINGS

Other features and advantages of the invention will become apparent from the following more detailed step by step description, taken in conjunction with the accompanying screen shots of the application, which illustrate the invention.

FIG. 1. Shows the main website of the www.bizlegalservices.com which is accessible to everyone over the internet. The “My Esq. Customer Portal” feature of the website allows clients to log-in to the invention or make a new request for registration to have access to the invention.

FIG. 2. Perspective illustration of the invention, illustrating the PETITION tab in the designated customer portal account. The web-based application will have a button designated to create a specific immigration petition. By clicking the petition tab, clients will be able to see the different types of immigration petitions.

FIG. 3. Illustrates the case creating button in the invention. As an example, the figure illustrates H-1B visa petitions. “Create H1B Petition” button, as shown in the figure, will submit a petition request from clients to the firm.

FIG. 4-6. Shows how clients give detailed information regarding their beneficiaries. Clients will fill in or select beneficiaries' first and last NAMES, proper SALUTATION, and E-MAIL Client will also select nature of the visa, and other pertaining details such as educational evaluation, and premium processing. Clients will also be able to select priority of the petition as HIGH, MEDIUM and LOW.

FIG. 7. Illustrates the last step in the case creation process. After entering all the necessary data, clients will be provided with an electronically service agreement. Once clients accept the agreement by clicking “SUBMIT” button, their cases will automatically, be created and assigned to qualified attorneys.

FIG. 8. Illustrates the instant message that clients will get once they accepted the service agreement by clicking “submit” button as shown above. Clients will automatically be provided with their PETITION NUMBER and the petition they created will automatically be forwarded to their beneficiaries with links and further instructions. Clients will also be able to see and make any changes from the list of cases they created.

FIG. 9. Illustrates the feature of the customer portal where attorneys update the progress of the case for clients and their beneficiaries. In this feature of the invention, clients and beneficiaries will be able to review the information and documents prepared by the attorneys and give comments to the same. Clients and beneficiaries also upload the necessary documents in support of their cases in this feature of the invention.

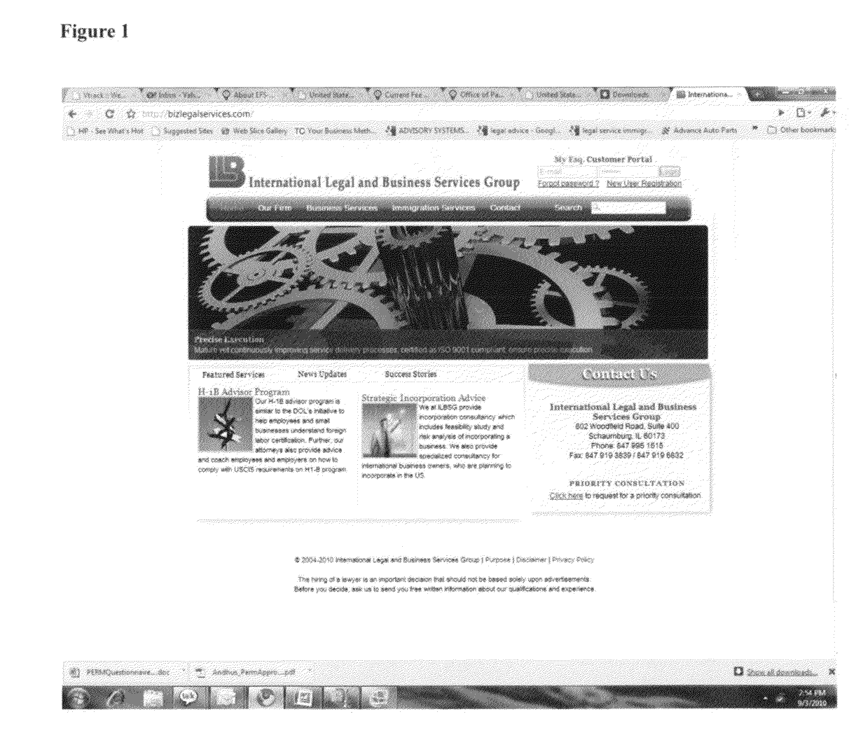

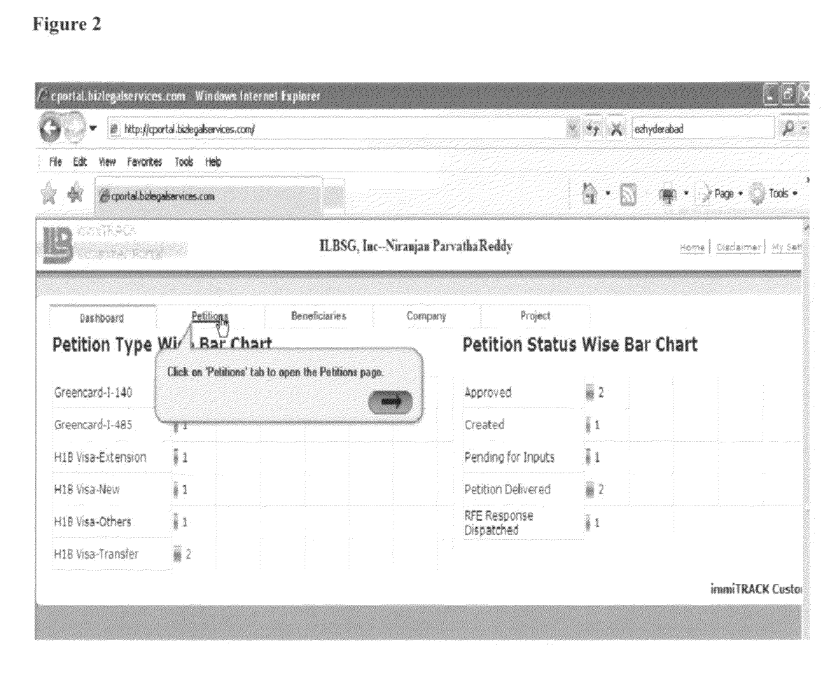

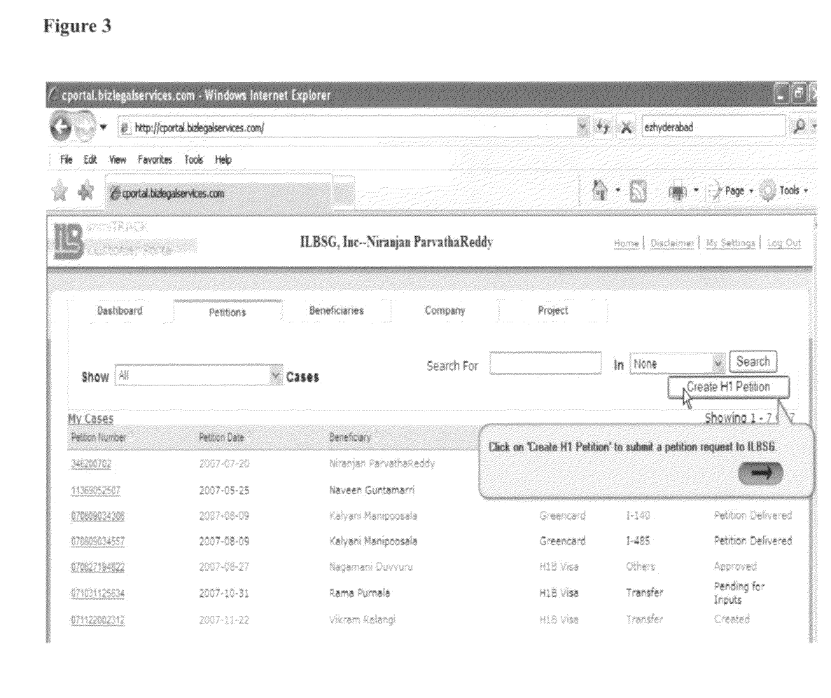

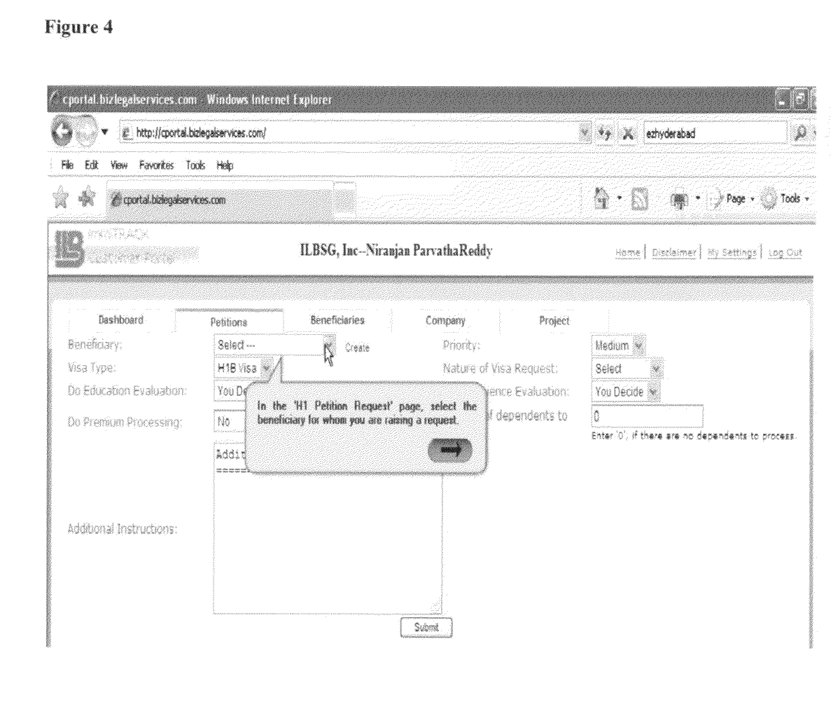

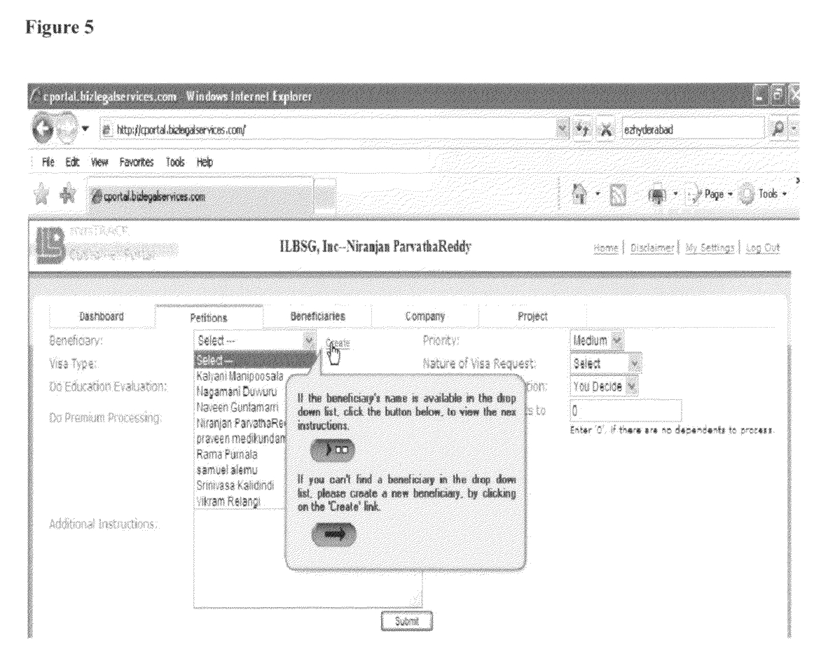

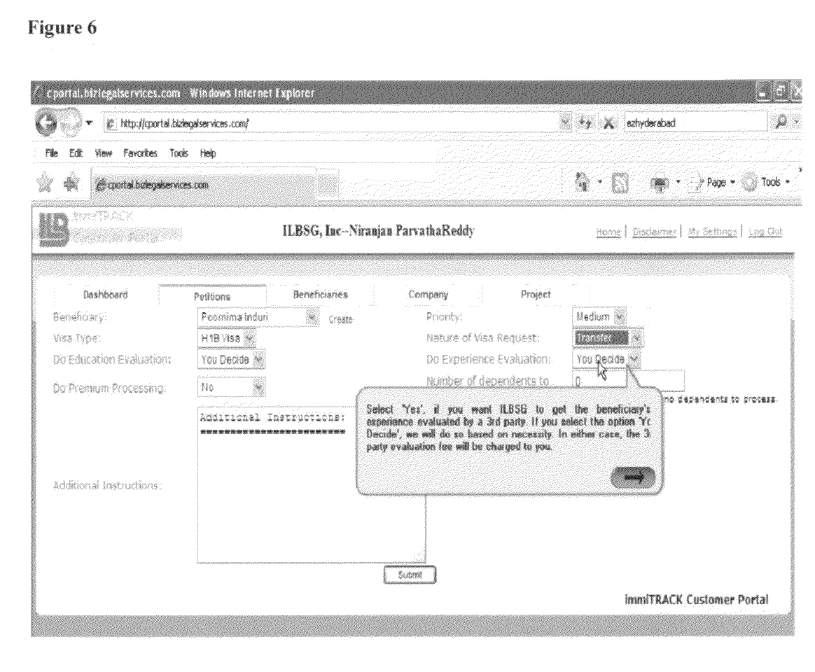

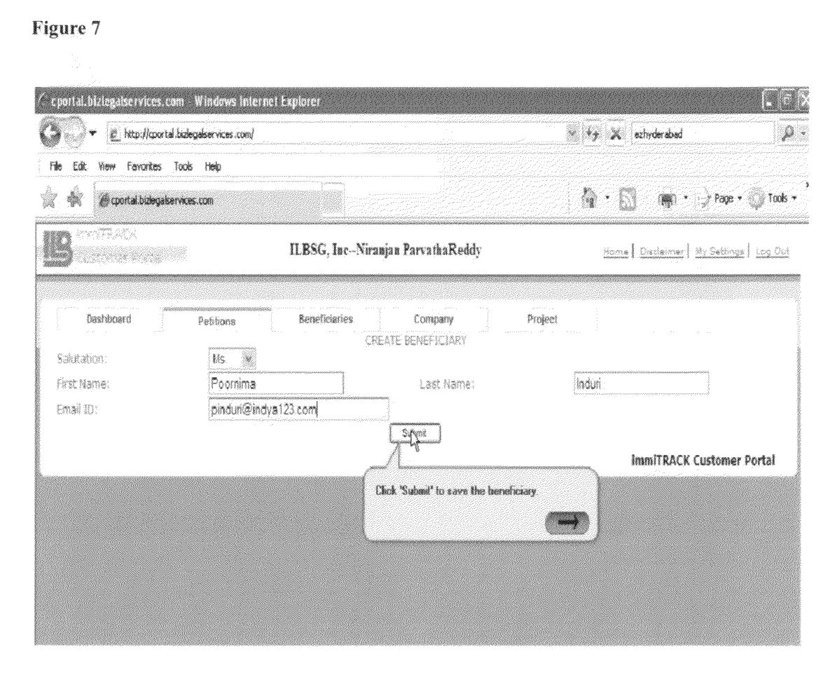

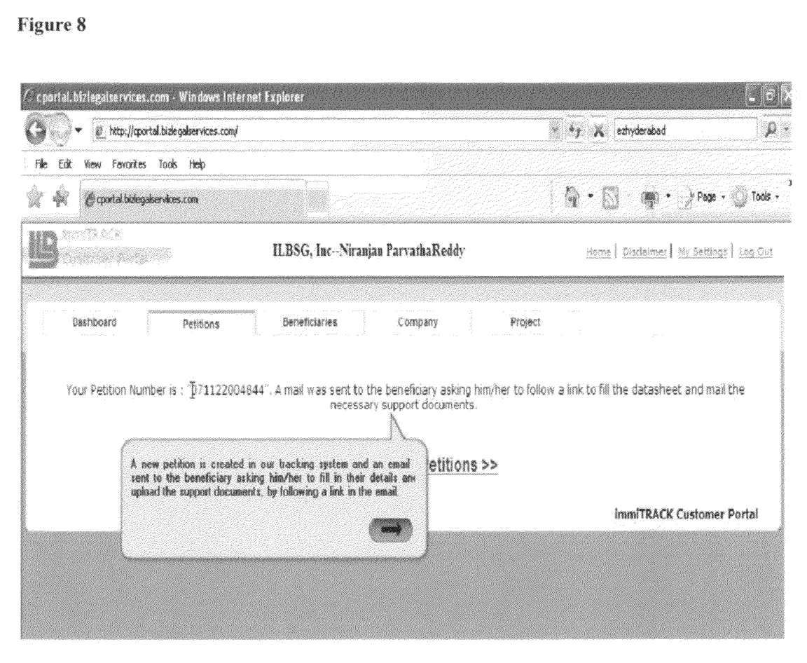

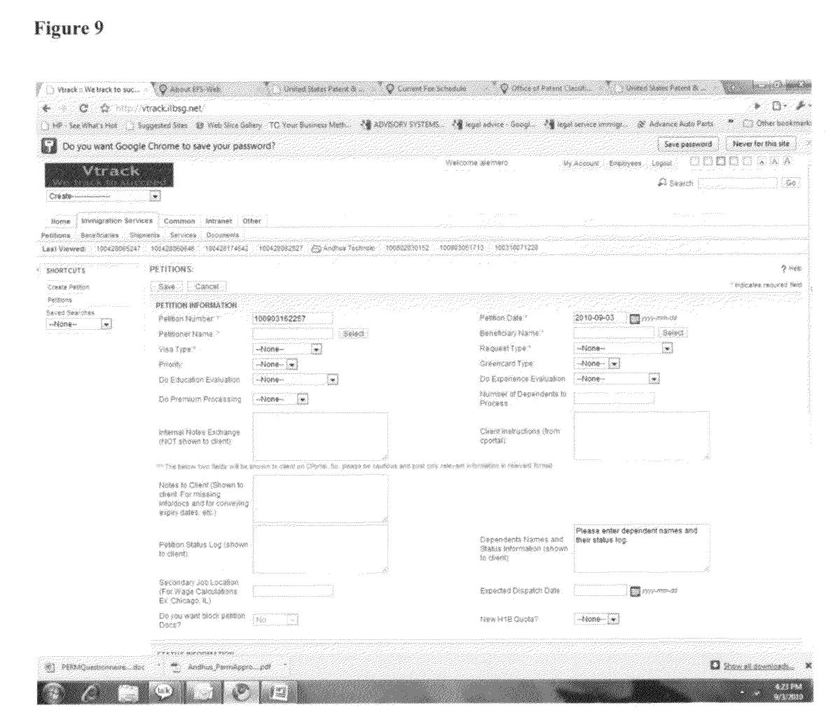

What is claimed is:

1. The web-based case creation system including: “My Esq. Customer Portal” which allows clients to login to their customer portal.

2. The web-based case creation system recited in claim 1 wherein Clients are able to create immigration petitions for themselves and/or their beneficiaries by petition type.

3. The web-based case creation system recited in claim 2 wherein Clients are able to feed in detailed information (name, e-mail, petition type, case priority etc) regarding themselves or their beneficiaries for whom they are initiating the immigration petition.

4. The web-based case creation system recited in claim 3 wherein Clients are able to create immigration petition and get a conformation petition number with a single click on submit bottom.

5. The web-based case creation system recited in claim 4 wherein a confirmation e-mail is sent to the beneficiaries of such immigration petition with link embodying detailed instruction as to the documents and information required from the beneficiaries' side.

6. The' web-based case creation system recited in claim 5 wherein clients and beneficiaries will be able to closely follow-up the progress of their cases as updated from time to time by the lawyer handling the case. It also includes the customer portal wherein beneficiaries of an immigration petition upload necessary documents for the case in progress.
